(19) United States
(12) Patent Application Publication
(10) Pub. No.: US 2009/0271458 A1
(43) Pub. Date: Oct. 29, 2009

(54) DATA STORAGE SYSTEM AND STORING METHOD THEREOF

(76) Inventors: Zhe-Hong Guo, Taipei City (TW); Hui-Hsuan Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/195,427

(22) Filed: Aug. 21, 2008

(30) Foreign Application Priority Data
Apr. 24, 2008 (CN) 200810095493.6

(51) Int. Cl. G06F 12/02; G06F 12/00

(52) U.S. Cl. 707/205; 707/E17.01; 707/E17.044

(57) ABSTRACT

A data storing method includes providing a storage space, receiving a data stream, establishing a cluster link when the data stream is stored into the storage space, and before the data stream is completely stored in the storage space, storing a cluster number of a specific node in the cluster link and information about a cluster following the specific node, and setting the content of the specific node as an EOF. A data storage system thereof can access a real-time data stream stored in the storage space, or release the occupied space in the storage space through deleting the file of the real-time data stream, even if the real-time data stream is interrupted abnormally during storage.

### BACKGROUND OF THE INVENTION

1. Field of the Invention

The present invention relates to a data storage system and a data storing method thereof, and more particularly, to a data storage system and a data storing method thereof that can read a stored real-time data stream or release the space occupied by the stored real-time data stream even if the real-time data stream is being stored and the storage is interrupted abnormally.

2. Description of the Prior Art

In general, when data is stored into a hard disc, a ‘cluster’ is taken as a unit of the data, and a file system is used to record a file name of the data and cluster numbers of the clusters in the hard disc that the data information occupies. Taking a file allocation table (FAT) system as an example, a directory entry is set up to record the file name and the first cluster number that the data uses, and a cluster link is established to record the number of the other clusters that the data uses. The FAT shown in FIG. 1 represents that the data of a file is stored in cluster 3, cluster 4, cluster 5, cluster 10 and cluster 12 sequentially, and the cluster 12 is shown the EOF that represents an end of file.

When an operating system (OS) is reading a file, it sequentially reads data from the hard disc according to the directory entry and the FAT of the file. Similarly, the OS deletes the file by removing the directory entry and the cluster link recorded in the FAT. As long as the directory entry is removed, the file system considers that the file is deleted, while removing the cluster link stands for releasing the space occupied by the data. However, storing a real-time data with indefinite size utilizing this method may cause problems. As the size of the real-time data is indefinite during the transmission, after establishing the directory entry, the file system needs to update the cluster link in the FAT in synchronization with data storage. If the data storage is interrupted abnormally due to accidents (such as system power off or accidental removal of the hard disc) thereby making the recorded cluster link not complete (lack of an EOF), not only will the incomplete data stream stored in the hard disc be unusable, but the incomplete cluster link will also be un-releasable. As a result, the disc space cannot be released even if the user deletes the directory entry, and the disc space occupied by the incomplete data stream is wasted.

### SUMMARY OF THE INVENTION

One objective of the present invention is therefore to provide a data storage system and a data storing method thereof that is capable of deleting or accessing a stored real-time data stream even if the storage of the real-time data stream is interrupted abnormally. The utilization efficiency of a storage device (such as a hard disc, a USB flash drive or a memory card) can thereby be maximized while not affecting its real-time operation.

According to one exemplary embodiment of the present invention, a data storing method is provided. The data storing method comprises providing a storage space, receiving a data stream, storing the data stream into the storage space, and recording the cluster number in the storage space that the data stream uses to establish a cluster link, wherein when the data stream is stored into the storage space, a cluster number of a first specific node in the cluster link and a first information about a number of the following cluster corresponding to the first specific node are further recorded in the storage space.

According to another exemplary embodiment of the present invention, a data storage system is provided. The data storage system comprises an access system and a processor coupled to the access system. The access system allocates a storage space, and the processor processes the accessing of a data stream. The processor stores the data stream into the access system, records the cluster number in the access system used by the data stream to establish a cluster link, and, before the data stream is completely stored in the access system, further stores a first information regarding a number of a first specific node in the cluster link and a number of the following cluster corresponding to the first specific node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a FAT established by a conventional FAT system during data storage.

FIG. 2 is a diagram of a data storage system according to one exemplary embodiment of the present invention.

FIG. 3(a) to FIG. 3(c) show an example of a FAT established by the data storage system of FIG. 2 and node information stored by the data storage system during data storage.

FIG. 4 shows another example of a FAT established by the data storage system of FIG. 2 and node information stored by the data storage system during data storage.

### DETAILED DESCRIPTION

The data storage system and the data storing method thereof provided by the present invention can ensure that, even when the storage of a real-time data stream (for example, a video stream or an audio stream) is interrupted abnormally, the data storage system can still access the stored data stream or delete it to release the occupied space. In this way, the real-time operation of a storage device will not be affected, and the utilization efficiency can thereby be improved. The problem of the established file being damaged and therefore unable to be deleted completely if the storage of the real-time video or audio stream in a conventional file system is interrupted can be solved therefore.

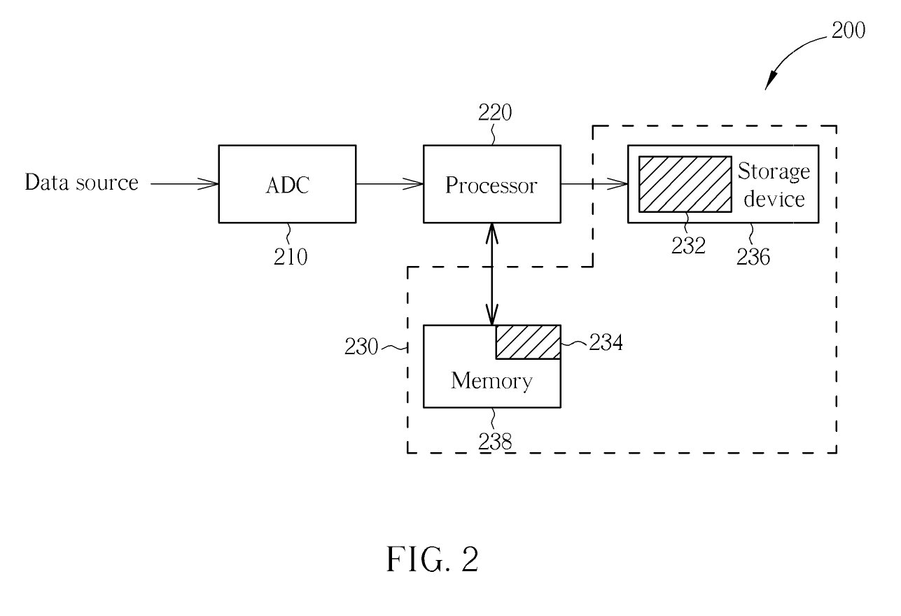

Please refer to FIG. 2, which is a diagram of a data storage system according to one exemplary embodiment of the present invention. The data storage system 200 includes an analog-to-digital converting circuit (ADC) 210, a processor 220, and an access system 230, wherein the access system 230 allocates a first storage space 232 and a second storage space 234. The first storage space 232 is utilized to store a digital data stream output by the ADC 210 and a cluster link of the data stream. The second storage space 234 is utilized to temporarily store information of some specific nodes in the cluster link and provide the information to the processor 220. In this embodiment, the first storage space 232 is located in a storage device 236, such as an optical disc, a hard disc, a memory card or an external flash drive, and the second storage space 234 is located in a memory 238, such as a Static Random Access Memory (SRAM). Of course, the first storage space 232 and the second storage space 234 can both be located in the storage device 236 or in the memory 238.

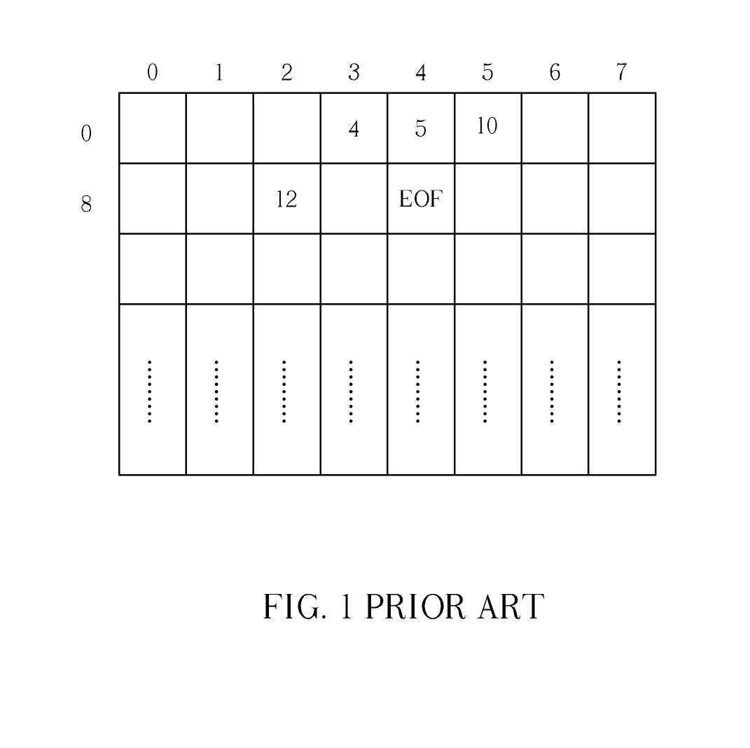

After the ADC 210 converts the data source into a digital data stream, the processor 220 stores the data stream into the first storage space 232, and records the cluster numbers occupied by the data stream with a cluster link (for example, the cluster link shown in FIG. 1). Moreover, before the data stream is completely stored in the first storage space 232, the processor 220 further stores a cluster number of a specific node (e.g. a node in which the data stream is stored lately) in the cluster link and an information about a next cluster number of a following cluster corresponding to the specific node into the second storage space 234, and sets the content of the specific node to be an end of file (called EOF hereinafter). In one embodiment, before the data stream is completely stored into the first storage space 232, cluster numbers of a node that the data stream is stored in lately and a node that the data stream will be stored in are record into the second storage space 234, and the content of the node that the data stream is stored in lately is then set to be an EOF. For illustration, the following takes the file allocation table (FAT) shown in FIG. 1 as an example to show the operations of the processor 220 during data storage. However, the implementation of the present invention is not limited to the FAT file system.

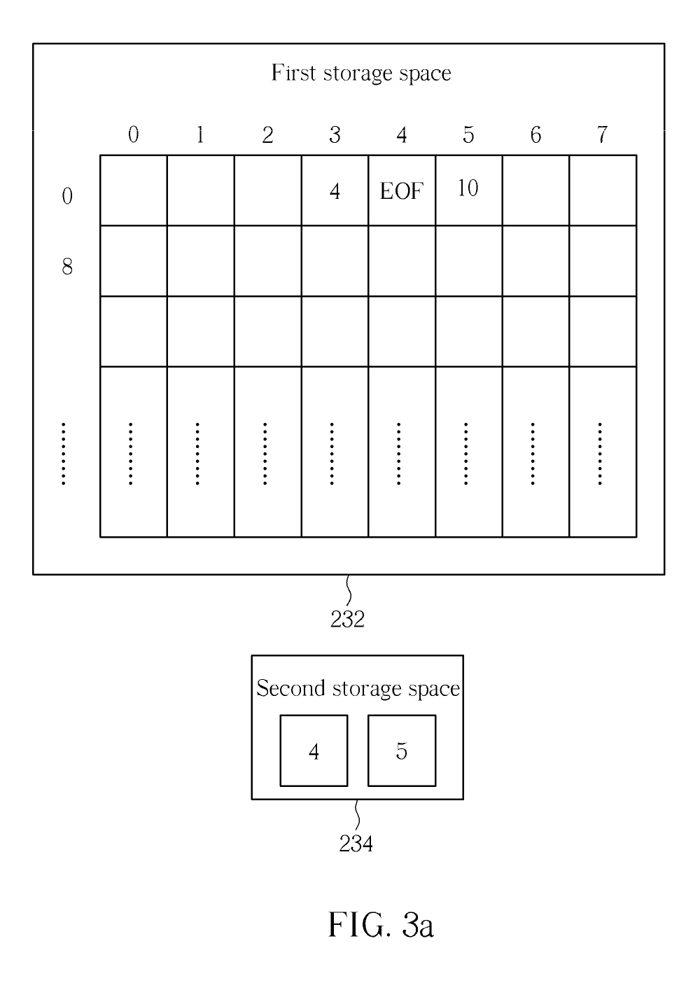

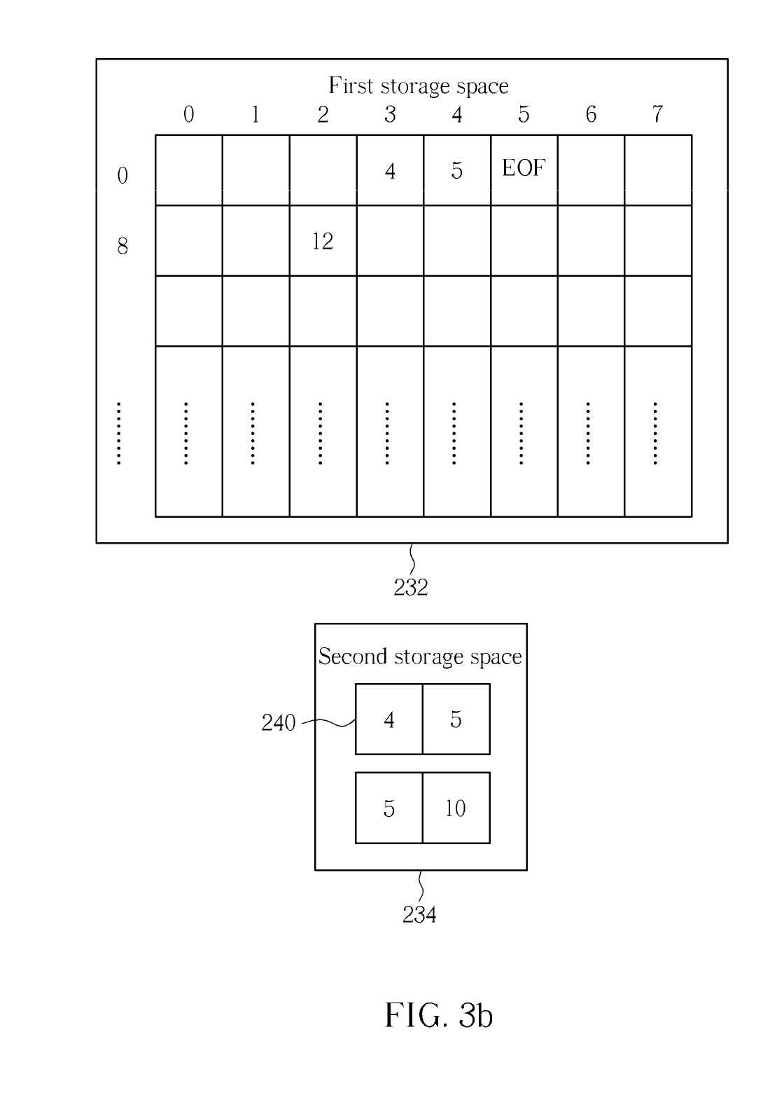

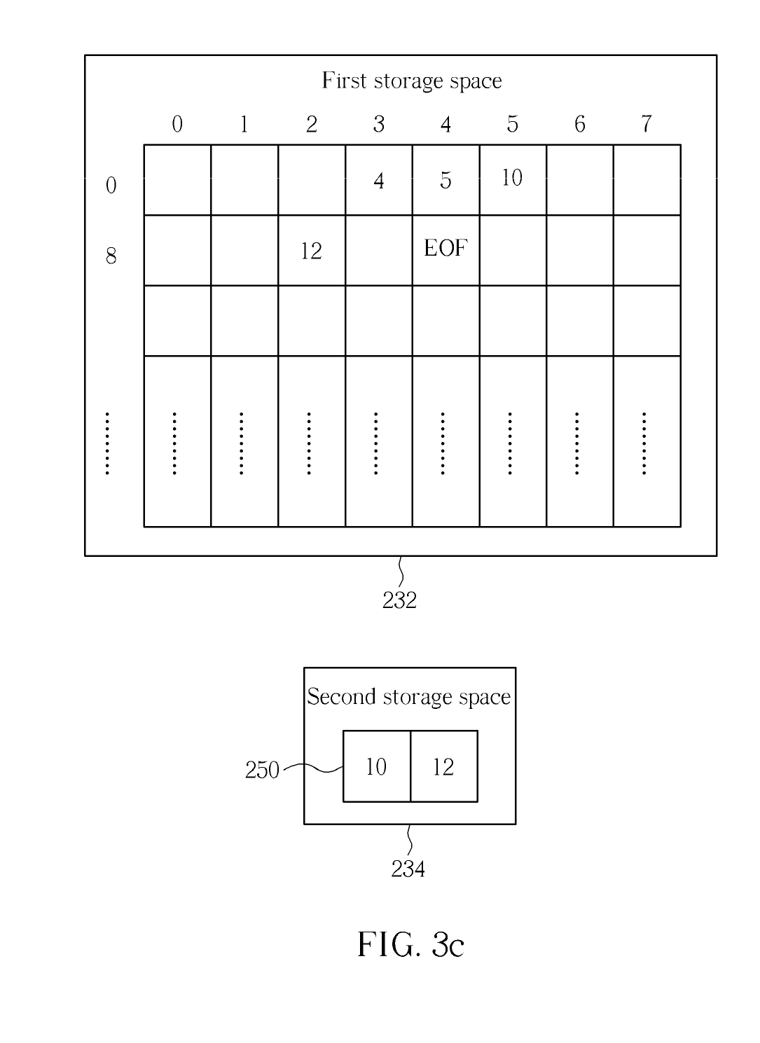

Please refer to FIG. 3(a) to FIG. 3(c). The processor 220 establishes a FAT in the first storage space 232 to record the cluster number that the data stream uses when being stored into the first storage space 232. During the process of data storage and cluster link establishment, each time a specific time interval passes by, the processor 220 records a cluster number of a newest cluster in the cluster link and a cluster number of a following cluster that the data stream uses after the newest cluster. In one embodiment, the processor 220 records the cluster number of cluster 4 and the cluster number of the following cluster corresponding to the cluster 4 (i.e. the cluster number of cluster 5 because, in this embodiment, the data stream is stored into cluster 5 subsequently) in the second storage space 234, and modifies the content of cluster 4 to become the EOF, as shown in FIG. 3(a). Next, after the specific time interval, as shown in FIG. 3(b), the processor 220 records the cluster number of the newest cluster used by the data stream (cluster 5 in this embodiment) and the cluster number of the following cluster (cluster 10 in this embodiment) in the second storage space 234 again, and sets the content of the cluster 5 as the EOF. The processor also recovers the content of the cluster 4 to let it point to cluster 5 according to the information 240 stored in the second storage space 234. The above steps will be repeated until the data stream has been completely stored in the first storage space 232. Then, as shown in FIG. 3(c), the processor 220 sets the content of the last cluster (i.e. cluster 12) as the EOF, and reads a newest information 250 stored in the second storage space 234 to recover the content of a cluster corresponding to the newest information to be its following cluster number; that is, to recover the content of cluster 5 as pointing to cluster 10.

Please note that FIG. 3(a) to FIG. 3(c) are only for illustrative purposes and are not a limitation of the present invention. In practical implementation, it is not necessary to perform node information recording and replacing cluster content by the EOF once a cluster time period passes by. Instead, a proper specific time period is set according to user requirements.

By setting an EOF in the FAT every specific time interval, the data storage system 200 can ensure that, when establishing a real-time file, the cluster link will contain one EOF each time, and the EOF can be very close to the storage progress of the data stream by choosing the time interval based on the system performance. The present invention therefore is able to solve the problems of prior arts: when the data stream storage is interrupted abnormally due to system power off or accidental removal of the storage device 236, the cluster link established by the data storage system 200 is still a legal cluster link for the operation system (OS) cause of the cluster link includes one EOF. Therefore, the user can read most of the data stream (from cluster 3 to the current EOF as shown in FIG. 3) from the storage device 236, or release most space occupied by the data stream in the storage device 236 by deleting the file; the utilization efficiency of the storage device 236 is thereby considerably improved.

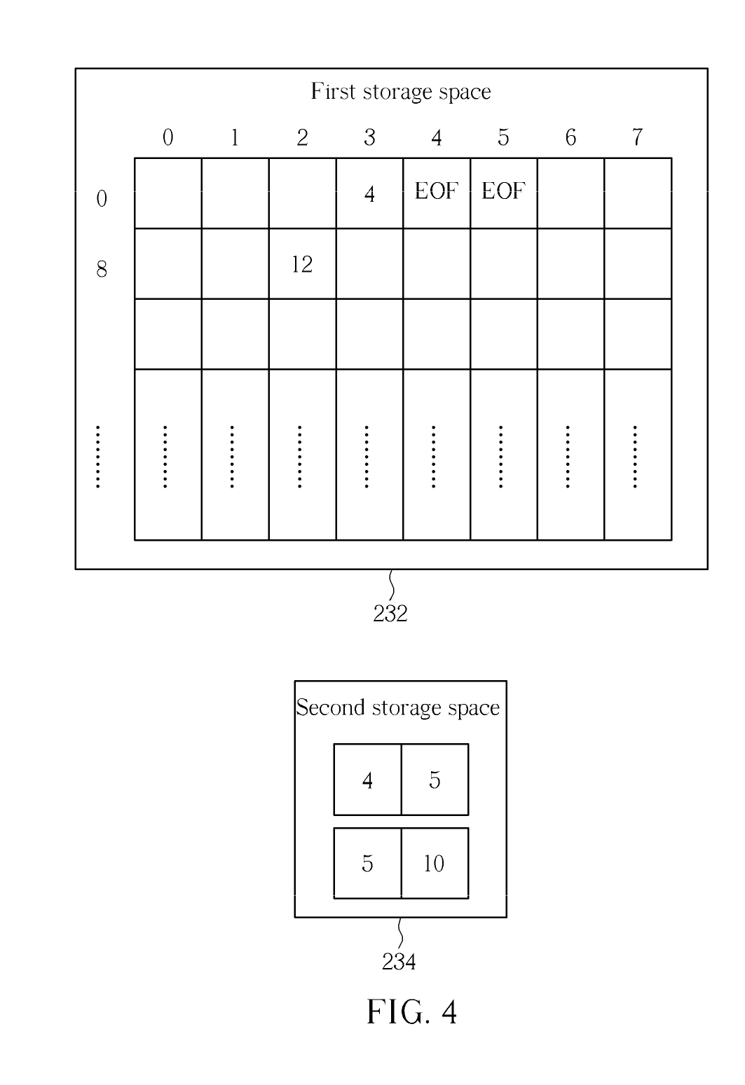

FIG. 4 shows another possible situation of data storage: an accident such as system power off or accidental removal of the storage device 236 happens after the processor 220 modifies the content of the newest cluster to be the EOF but before the processor 220 recovers the content of the former modified cluster. In FIG. 4, the processor 220 has modified the content of cluster 4 as the EOF, recorded the cluster number of cluster 5 and the cluster number of the next cluster (cluster 10) in the second storage space 234, and set the content of cluster 5 to be the EOF. However, before the processor 220 recovers the content of cluster 4 as pointing to cluster 5 according to the information stored in the second storage space 234, the storage process has been interrupted abnormally. In this situation, the cluster link will have two EOFs, and the link starting from cluster 3 to EOF of cluster 4 will be regarded as a legal cluster link. Hence, the user can read data stored in cluster 3 and cluster 4, or release the space of cluster 3 and cluster 4 by deleting the file. This still improves the utilization efficiency of the storage device 236.

In another embodiment, the above-mentioned second storage space 234 and memory 238 are omitted in the data storage system 200. The data storage system 200 directly stores the information of the specific nodes and the following cluster numbers corresponding to the specific nodes in the first storage space 232 (such as a flash originally existing in the system). Instead of temporarily storing the information in the second storage space 234, the processor 220 directly stores the digital data stream, the cluster link of the data stream, and information of the specific nodes and the following cluster numbers corresponding to the specific nodes into the first storage space 232. According to this method, the advantages of the storage device 236 reading the stored data stream or releasing the occupied space can also be achieved.

Those skilled in the art will readily observe that numerous modifications and alterations of the device and method may be made while retaining the teachings of the invention.

What is claimed is:

1. A data storing method, comprising:
providing a storage space;
receiving a data stream;
storing the data stream into the storage space; and
recording at least a cluster number that the data stream uses in the storage space to establish a cluster link;
wherein when the data stream is stored in the storage space, a cluster number of a first specific node in the cluster link and a first information about a number of a following cluster corresponding to the first specific node are further stored.

2. The data storing method of claim 1, further comprising:
setting a content of the first specific node representing as an end of file (EOF).

3. The data storing method of claim 1, wherein the step of storing the data stream into the storage space further comprises:
storing a cluster number of a second specific node in the cluster link and a second information about a number of a following cluster corresponding to the second specific node; and
setting a content of the second specific node representing as an end of file (EOF).

4. The data storing method of claim 3, wherein the cluster link comprises at least one end of file (EOF).

5. The data storing method of claim 3, further comprising:
setting the content of the second specific node as the number of the following cluster corresponding to the first specific node according to the first information.

6. The data storing method of claim 1, further comprising:
when the data stream is completely stored in the storage space, setting a content of a node corresponding to a newest information as a cluster number of a cluster that the data stream uses following the node according to the newest information.

7. The data storing method of claim 1, wherein the data stream is a real-time video or audio stream.

8. The data storing method of claim 1, wherein the storage space comprises a first storage space and a second storage space, the data stream is stored in the first storage space, and the first information is temporarily stored in the second storage space.

9. A data storage system, comprising:
an access system; and
a processor, coupled to the access system, for processing an access to a data stream, storing the data stream into the access system, recording a cluster number that the data stream uses in the access system to establish a cluster link, and, before the data stream is completely stored in the access system, storing a cluster number of a first specific node in the cluster link and a first information about a next cluster number of a following cluster corresponding to the first specific node.

10. The data storage system of claim 9, wherein the processor further sets a content of the first specific node as an end of file (EOF).

11. The data storage system of claim 10, wherein before the data stream is completely stored in the access system, the processor further stores a cluster number of a second specific node in the cluster link and a second information about a next cluster number of a following cluster corresponding to the second specific node, and the processor sets a content of the second specific node as an end of file (EOF).

12. The data storage system of claim 11, wherein the cluster link comprises at least one end of file (EOF).

13. The data storage system of claim 9, wherein the access system allocates a first storage space and a second storage space, and the processor stores the data stream in the first storage space, and temporarily stores the first information in the second storage space.

14. The data storage system of claim 9, wherein the first storage space is located in a removable device.
